(19) United States
(12) Patent Application Publication
(10) Pub. No.: US 2013/0328865 A1
(43) Pub. Date: Dec. 12, 2013

(54) APPARATUS AND METHOD FOR GRAPHIC OFFLOADING BASED ON VIRTUAL MACHINE MONITOR

(71) Applicant: Electronics and Telecommunications Research Institute, (US)

(72) Inventors: Won-Hyuk CHOI, Daejeon (KR); Won-Young Kim, Daejeon (KR); Su-Min Jang, Daejeon (KR)

(73) Assignee: ELECTRONICS AND TELECOMMUNICATIONS RESEARCH INSTITUTE, Daejeon-city (KR)

(21) Appl. No.: 13/803,129

(22) Filed: Mar. 14, 2013

(30) Foreign Application Priority Data
Jun. 12, 2012 (KR) 10-2012-0066

(51) Int. Cl. G06T 15/00

(52) U.S. Cl. CPC G06T 15/00
USPC 345/419

(57) ABSTRACT

Disclosed herein is an apparatus and method for graphic offloading based on a virtual machine monitor. A graphic offloading server device includes a virtual machine unit for performing graphics processing of three-dimensional (3D) graphics software, and a virtual machine monitor unit for transmitting graphics processing instructions of the 3D graphics software input from the virtual machine unit to a graphic offloading client device using a pass-through technique, so that the graphic offloading client device actually performs graphics processing of the 3D graphics software. The graphic offloading server device virtually performs graphics processing of the 3D graphics software in a desktop virtualization environment

### CROSS REFERENCE TO RELATED APPLICATION

This application claims the benefit of Korean Patent Application No. 10-2012-0066779, filed on Jun. 21, 2012, which is hereby incorporated by reference in its entirety into this application.

### BACKGROUND OF THE INVENTION

1. Technical Field

The present invention relates generally to an apparatus and method for graphic offloading based on a virtual machine monitor and, more particularly, to an apparatus and method for graphic offloading based on a virtual machine monitor, which allow data tasks related to graphics processing to be performed by a server and actual graphics processing tasks to be performed by client computers, in a divided manner.

2. Description of the Related Art

Virtualization technology is a concept introduced in 1960 to use a single mainframe-level server to be virtually used as a plurality of machines in a divided manner. In consideration of the fact that the use rate of servers at that time was about 10˜20%, a plurality of servers are caused to operate on a virtual machine located at a higher level than a single physical server, so that the actual use rate of servers can be increased and security can also be maintained. Since then, with the improvement of performance of desktop Personal Computers (PCs), servers can be implemented using even desktop PCs, and thus the requirement for virtualization technology has gradually decreased.

However, recently, desktop virtualization technology for providing a user task environment using server virtualization technology has been widely popularized. Desktop virtualization technology is mainly introduced to task environments in which important data for security needs to be handled, such as in medicine, bioinformatics, and three-dimensional (3D) graphic models having a complicated structure such as design drawings. Then, such desktop virtualization technology has attracted attention as a method that is capable of solving various problems, such as management of hardware and prompt recovery of systems damaged by disasters.

Further, desktop virtualization technology is also referred to as a hypervisor, a virtual Operating System (OS), or a Virtual Machine Monitor (VMM) (software for virtualizing and providing resources such as a Central Processing Unit (CPU) or a memory device to a virtual machine, and also referred to as a virtualization layer), and can be mainly classified into two types, that is, hypervisor virtualization and host-based virtualization.

However, the desktop virtualization technology is characterized in that software (SW) is executed by a server and a client computer simply functions as a terminal, and is then limited in performing high-performance graphical tasks, such as 3D rendering, because the load of the server increases as the number of clients increases.

In relation to this, Korean Patent No. 10-1077908 discloses technology for providing a server virtualization apparatus that improves performance by combining hardware virtualization-supporting technology with para-virtualization technology. However, this para-virtualization technology requires the revision of a guest OS so as to use Application Programming Interface (API)-level graphics processing instructions, so that the guest OS can use only open sources, such as Linux, and can then be virtualized only in a unique platform.

### SUMMARY OF THE INVENTION

Accordingly, the present invention has been made keeping in mind the above problems occurring in the prior art, and an object of the present invention is to provide an apparatus and method for graphic offloading based on a virtual machine monitor, which transmit graphics processing instructions, executed using a virtual machine monitor-based virtual machine in a desktop virtualization environment, to a client via a pass-through technique, so that the client can perform actual high-performance graphics processing, such as rendering, thus enabling fast graphics processing to be performed without a separate additional server being constructed.

Another object of the present invention is to provide an apparatus and method for graphic offloading based on a virtual machine monitor, which allow a client to perform graphics processing with improved performance compared to prior technology by transmitting information about only PCI-level graphics processing instructions to the client

In accordance with an aspect of the present invention to accomplish the above objects, there is provided a graphic offloading server device, including a virtual machine unit for performing graphics processing of three-dimensional (3D) graphics software; and a virtual machine monitor unit for transmitting graphics processing instructions of the 3D graphics software input from the virtual machine unit to a graphic offloading client device using a pass-through technique, so that the graphic offloading client device actually performs graphics processing of the 3D graphics software, wherein the graphic offloading server device virtually performs graphics processing of the 3D graphics software in a desktop virtualization environment.

Preferably the virtual machine unit may include a graphics library unit for performing graphics processing of the 3D graphics software requested by a user to be executed using Application Programming Interface (API)-level graphics processing instructions; and a graphics drive unit for converting the API-level graphics processing instructions into Peripheral Component Interconnect (PCI)-level graphics processing instructions.

Preferably, the virtual machine monitor unit may include a virtual pass-through transmission unit for transmitting the PCI-level graphics processing instructions using a pass-through technique.

In accordance with another aspect of the present invention to accomplish the above objects, there is provided a graphic offloading client device, including a pass-through reception unit for receiving graphics processing instructions, transmitted from a graphic offloading server device for virtually performing graphics processing of three-dimensional (3D) graphics software in a desktop virtualization environment, using a pass-through technique; and a graphics processing unit for performing graphics processing by rendering the received graphics processing instructions, wherein the graphic offloading client device actually performs graphics processing of the 3D graphics software.

Preferably, the graphics processing instructions transmitted from the graphic offloading server device may be graphics processing instructions converted into Peripheral Component Interconnect (PCI)-level instructions.

Preferably, the graphic offloading client device may further include a display device for displaying results of actual graphics processing performed by the graphics processing unit on a display screen.

In accordance with a further aspect of the present invention to accomplish the above objects, there is provided a method of graphic offloading based on a virtual machine monitor, including virtually performing, by a graphic offloading server device, graphics processing of three-dimensional (3D) graphics software in a desktop virtualization environment; transmitting, by the graphic offloading server device, graphics processing instructions based on graphics processing of the 3D graphics software to a graphic offloading client device using a pass-through technique; and receiving, by the graphic offloading client device, the graphics processing instructions and then actually performing graphics processing of the 3D graphics software.

Preferably, the transmitting the graphics processing instructions to the graphic offloading client device using the pass-through technique may be configured such that the graphics processing instructions are converted from Application Programming Interface (API)-level graphics processing instructions into Peripheral Component Interconnect (PCI)-level graphics processing instructions, and the PCI-level graphics processing instructions are transmitted.

Preferably, the receiving the graphics processing instructions and actually performing the graphics processing of the 3D graphics software may be configured such that the graphics processing instructions are graphics processing instructions converted into PCI-level instructions.

Preferably, the receiving the graphics processing instructions and actually performing graphics processing of the 3D graphics software may be configured to perform graphics processing by rendering the graphics processing instructions converted into the PCI-level instructions.

Preferably, the method may further include, after receiving the graphics processing instructions and actually performing graphics processing of the 3D graphics software, displaying, by a display device, results of actual graphics processing on a display screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for graphic offloading based on a virtual machine monitor according to an embodiment of the present invention;

FIG. 2 is a block diagram showing the detailed configuration of a virtual machine monitor-based graphic offloading server device according to an embodiment of the present invention;

FIGS. 3 and 4 are block diagrams showing the detailed configuration of a virtual machine unit and a virtual machine monitor unit employed in the virtual machine monitor-based graphic offloading server device according to an embodiment of the present invention;

FIG. 5 is a block diagram showing the detailed configuration of a virtual machine monitor-based graphic offloading client device according to an embodiment of the present invention; and

FIG. 6 is a flowchart showing a method of graphic offloading based on a virtual machine monitor using the graphic offloading server and client device according to an embodiment of the present invention.

### DESCRIPTION OF THE PREFERRED EMBODIMENTS

Preferred embodiments of the present invention will be described in detail below with reference to the accompanying drawings to such an extent that those skilled in the art can easily implement the technical spirit of the present invention. Reference now should be made to the drawings, in which the same reference numerals are used throughout the different drawings to designate the same or similar components. In the following description, redundant descriptions and detailed descriptions of known elements or functions that may unnecessarily make the gist of the present invention obscure will be omitted.

Hereinafter, a virtual machine monitor-based graphic offloading server and client device and a method of graphic offloading using the server and client devices according to embodiments of the present invention will be described in detail with reference to the attached drawings.

A virtual machine monitor unit in the present invention denotes a logical platform for simultaneously running a plurality of Operating Systems (OSs) on a host computer, and is also referred to as a “hypervisor.” In greater detail, the term “virtual machine monitor unit” denotes a thin layer of software for controlling methods by which different types of OSs access various host computer resources, such as processors or memory. That is, the virtual machine monitor unit refers to an effective virtualization engine that is used as a kind of middleware between a Central Processing Unit (CPU) and OSs so that a plurality of OSs can run on a single host computer system, and that can realize a virtual computer which uses different OSs on a single computer.

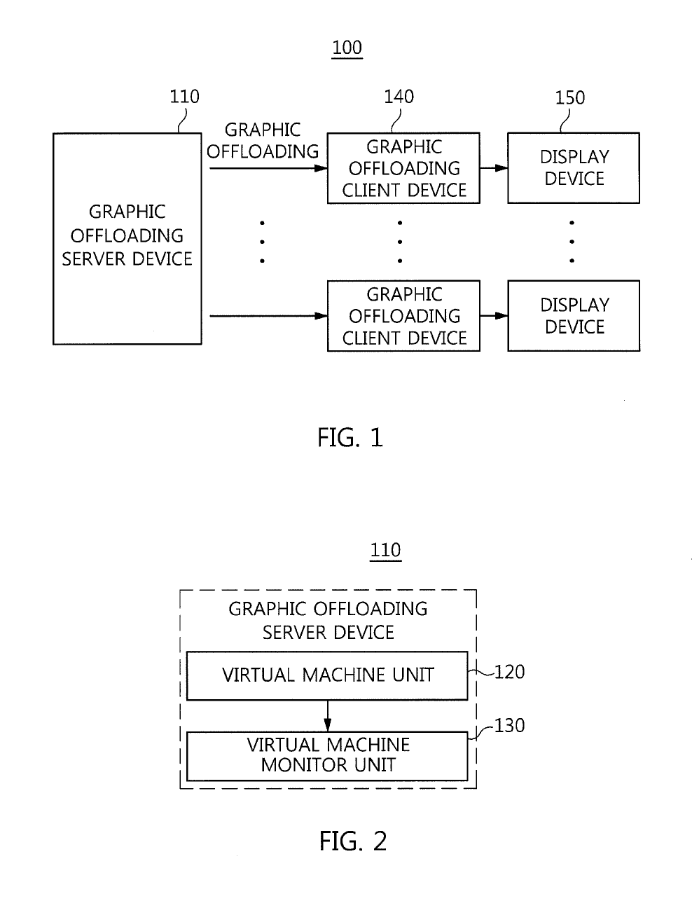

FIG. 1 is a block diagram showing an apparatus for graphic offloading based on a virtual machine monitor according to an embodiment of the present invention.

Referring to FIG. 1, an apparatus 100 for graphic offloading based on a virtual machine monitor according to the present invention includes a graphic offloading server device 110, graphic offloading client devices 140, and display devices 150, so as to perform graphics processing in a divided manner in such a way that data tasks related to graphics processing are performed by the server and actual graphics-processing tasks are performed by the clients.

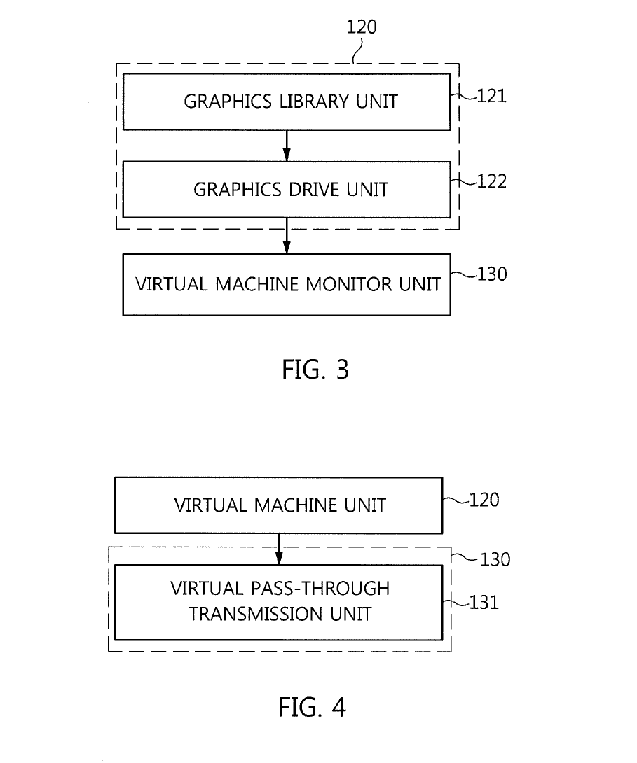

FIG. 2 is a block diagram showing the detailed configuration of a virtual machine monitor-based graphic offloading server device according to an embodiment of the present invention, and FIGS. 3 and 4 are block diagrams showing the detailed configuration of a virtual machine unit and a virtual machine monitor unit employed in the virtual machine monitor-based graphic offloading server device according to an embodiment of the present invention.

Referring to FIG. 2, a graphic offloading server device 110 virtually performs graphics processing of 3D graphics software in a desktop virtualization environment using a virtual machine monitor unit 130-based virtual machine unit 120.

The virtual machine unit 120 performs graphics processing of 3D graphics software.

For this, the virtual machine unit 120 may include a graphics library unit 121 and a graphics drive unit 122, as shown in FIG. 3.

The graphics library unit 121 performs graphics processing of 3D graphics software requested by a user to be executed using Application Programming Interface (API)-level graphics processing instructions.

The graphics drive unit 122 converts the API-level graphics processing instructions into Peripheral Component Interconnect (PCI)-level graphics processing instructions, and provides the PCI-level graphics processing instructions to the virtual machine monitor unit 130. That is, the graphics drive unit 122 converts graphics processing instruction information called at an API level into PCT-level graphics processing instruction information so that the graphics processing is actually performed by the graphics processing unit 142 of a graphic offloading client device 140. In this case, PCI protocol standards are data bus standards presented so as to solve problems that an excessive burden is exerted on a CPU and that fixed data bus specifications are not present in the field of 64-bit PCs in the case of Industry Standard Architecture (ISA), Extended ISA (EISA), MicroChannel (MCA), and Video Electronics Standards Association (VESA) buses that were previous bus standards.

The virtual machine monitor unit 130 transmits the graphics processing instructions input from the virtual machine unit 120 to the graphic offloading client device 140 using a pass-through technique, so that the graphic offloading client device 140 actually performs graphics processing of 3D graphics software.

For this, as shown in FIG. 4, the virtual machine monitor unit 130 may include a virtual pass-through transmission unit 131.

The virtual pass-through transmission unit 131 transmits the PCI-level graphics processing instructions converted by the graphics drive unit 122 using the pass-through technique. In this case, the pass-through technique is advantageous in that a transmission time is shorter than and an effective transmission rate is higher than those of a store-and-forward technique that transmits data after storing the data.

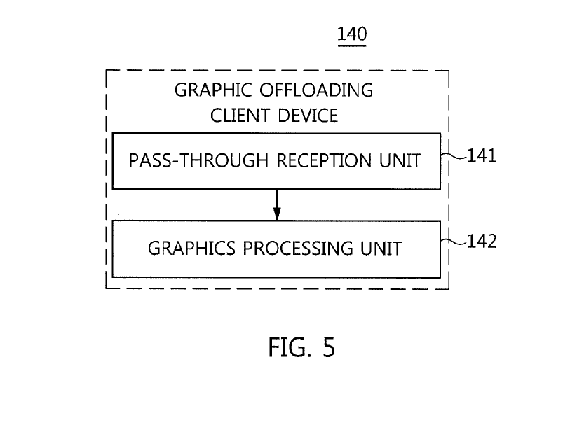

FIG. 5 is a block diagram showing the detailed configuration of a virtual machine monitor-based graphic offloading client device according to an embodiment of the present invention.

Referring to FIG. 5, a plurality of graphic offloading client devices 140 are provided, so that graphics processing of 3D graphics software is actually performed by each graphic offloading client device in compliance with graphics processing instructions received from the graphic offloading server device 110.

For this, as shown in FIG. 5, the graphic offloading client device 140 may include a pass-through reception unit 141 and a graphics processing unit 142.

The pass-through reception unit 141 receives graphics processing instructions transmitted from the virtual machine monitor unit 130 using a pass-through technique. In this case, the graphics processing instructions transmitted from the virtual machine monitor unit 130 are graphics processing instructions converted into PCI-level instructions by the graphics drive unit 122.

The graphics processing unit 142 performs actual graphics processing by rendering the received graphics processing instructions converted into the PCI-level instructions. Here, the term “rendering” refers to a procedure or technique for creating a realistic 3D image while considering shadow, color, density, etc. that appear differently depending on external information, such as shape, position, and lighting, on a planar picture. That is, rendering denotes a computer graphics procedure for assigning a three-dimensional effect by applying variations in shadow or density to an object shown as a planar shape, thus adding reality.

Each display device 150 displays the results of the actual graphics processing performed by the graphic offloading client device 140 on the display screen of the user.

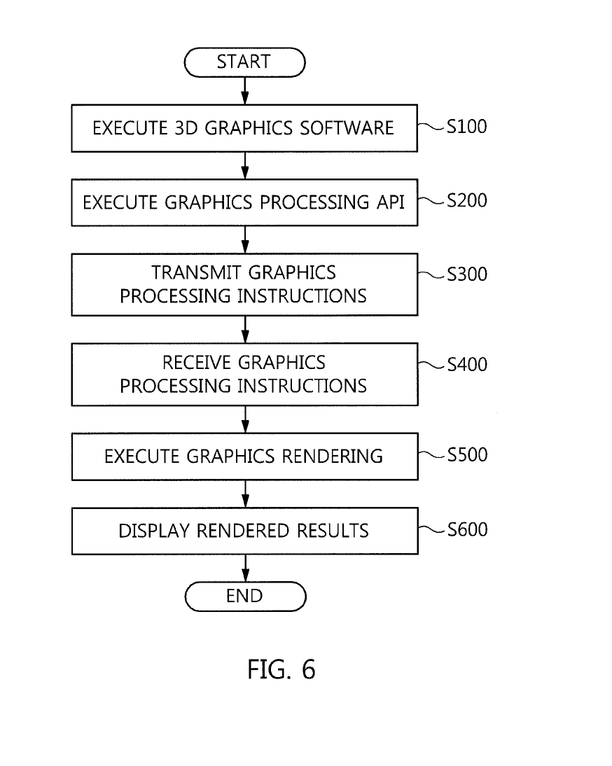

FIG. 6 is a flowchart showing a method of graphic offloading using the virtual machine monitor-based graphic offloading server and client device according to an embodiment of the present invention.

Referring to FIG. 6, a request for the execution of 3D graphics software is received from a user at step S100.

Next, graphics processing of the 3D graphics software is performed at an API level, that is, a library level, by the virtual machine unit 120 of the graphic offloading server device 110 in a server virtualization environment at step S200.

Then, graphics processing instructions input from the virtual machine unit 120 are transmitted to the graphic offloading client device 140 by the virtual machine monitor unit 130 of the graphic offloading server device 110 using a pass-through technique. At this step S300, the virtual machine unit 120 may convert the graphics processing instructions into PCI level-graphics processing instructions and transmit the PCI level-graphics processing instructions so that graphics processing is actually performed by the graphic offloading client device 140 using the graphics processing instructions extracted at the API level.

Thereafter, the graphic offloading client device 140 receives the graphics processing instructions at step S400. In this case, the received graphics processing instructions denote graphics processing instructions converted into the PCI- level instructions.

The graphic offloading client device 140 then performs graphics processing by rendering the received PCI-level graphics processing instructions at step S500.

Finally, the results of actual graphics processing that is, the results of rendering, are displayed on the display screen of the user via the display device 150 at step S600.

In this way, the present invention transmits graphics processing instructions executed in the desktop virtualization environment to the graphic offloading client device 140 via a pass-through technique using the virtual machine monitor unit 130-based virtual machine unit 120, so that the graphic offloading client device 140 performs actual high-performance graphics processing, such as rendering, thus enabling fast graphics processing to be performed without a separate additional server being constructed. Further, the present invention transmits information about only PCI-level graphics processing instructions to the graphic offloading client device 140, thus improving graphics processing performance of the graphic offloading client device 140.

As described above, the apparatus and method for graphic offloading based on a virtual machine monitor, having the above configuration, are advantageous in that graphics processing instructions, executed using a virtual machine monitor-based virtual machine in a desktop virtualization environment, are transmitted to a client via a pass-through technique, so that the client can perform actual high-performance graphics processing, such as rendering, thus enabling fast graphics processing to be performed without a separate additional server being constructed.

Further, the present invention is advantageous in that it allows a client to perform graphics processing with improved performance compared to prior technology by transmitting information about only PCI-level graphics processing instructions to the client

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A graphic offloading server device, comprising:
a virtual machine unit for performing graphics processing of three-dimensional (3D) graphics software; and
a virtual machine monitor unit for transmitting graphics processing instructions of the 3D graphics software input from the virtual machine unit to a graphic offloading client device using a pass-through technique, so that the graphic offloading client device actually performs graphics processing of the 3D graphics software,
wherein the graphic offloading server device virtually performs graphics processing of the 3D graphics software in a desktop virtualization environment.

2. The graphic offloading server device of claim 1, wherein the virtual machine unit comprises:
a graphics library unit for performing graphics processing of the 3D graphics software requested by a user to be executed using Application Programming Interface (API)-level graphics processing instructions; and
a graphics drive unit for converting the API-level graphics processing instructions into Peripheral Component Interconnect (PCI)-level graphics processing instructions.

3. The graphic offloading server device of claim 2, wherein the virtual machine monitor unit comprises a virtual pass-through transmission unit for transmitting the PCI-level graphics processing instructions using a pass-through technique.

4. A graphic offloading client device, comprising:
a pass-through reception unit for receiving graphics processing instructions, transmitted from a graphic offloading server device for virtually performing graphics processing of three-dimensional (3D) graphics software in a desktop virtualization environment, using a pass-through technique; and
a graphics processing unit for performing graphics processing by rendering the received graphics processing instructions,
wherein the graphic offloading client device actually performs graphics processing of the 3D graphics software.

5. The graphic offloading client device of claim 4, wherein the graphics processing instructions transmitted from the graphic offloading server device are graphics processing instructions converted into Peripheral Component Interconnect (PCI)-level instructions.

6. The graphic offloading client device of claim 4, further comprising a display device for displaying results of actual graphics processing performed by the graphics processing unit on a display screen.

7. A method of graphic offloading based on a virtual machine monitor, comprising:
virtually performing, by a graphic offloading server device, graphics processing of three-dimensional (3D) graphics software in a desktop virtualization environment;
transmitting, by the graphic offloading server device, graphics processing instructions based on graphics processing of the 3D graphics software to a graphic offloading client device using a pass-through technique; and
receiving, by the graphic offloading client device, the graphics processing instructions and then actually performing graphics processing of the 3D graphics software.

8. The method of claim 7, wherein the transmitting the graphics processing instructions to the graphic offloading client device using the pass-through technique is configured such that the graphics processing instructions are converted from Application Programming Interface (API)-level graphics processing instructions into Peripheral Component Interconnect (PCI)-level graphics processing instructions, and the PCI-level graphics processing instructions are transmitted.

9. The method of claim 7, wherein the receiving the graphics processing instructions and actually performing the graphics processing of the 3D graphics software is configured such that the graphics processing instructions are graphics processing instructions converted into PCI-level instructions.

10. The method of claim 9, wherein the receiving the graphics processing instructions and actually performing graphics processing of the 3D graphics software is configured to perform graphics processing by rendering the graphics processing instructions converted into the PCI-level instructions.

11. The method of claim 9, further comprising, after receiving the graphics processing instructions and actually performing graphics processing of the 3D graphics software, displaying, by a display device, results of actual graphics processing on a display screen.
